(19) United States
(12) Patent Application Publication
(10) Pub. No.: US 2018/0103429 A1
(43) Pub. Date: Apr. 12, 2018

(54) POWER SAVING METHOD OF WIRELESS ELECTRONIC DEVICES

(71) Applicant: CHIE-MING CHOU, Hsinchu (TW)

(72) Inventor: CHIE-MING CHOU, Hsinchu (TW)

(21) Appl. No.: 15/726,682

(22) Filed: Oct. 6, 2017

Related U.S. Application Data
(60) Provisional application No. 62/405,593, filed on Oct. 7, 2016.

(51) Int. Cl. H04W 52/02; H04W 68/02; H04W 76/04; H04W 76/06

(52) U.S. Cl. CPC H04W 52/0229; H04W 76/068; H04W 76/046; H04W 68/02

(57) ABSTRACT

A wireless electronic device is provided. The wireless electronic device in a wireless communication system has a first data transmission path with a core network. The wireless electronic device includes a processor configured to perform the following instructions. A second data transmission path with a second wireless electronic device, coupled to the core network, is established. An access stratum module of the wireless electronic device is deactivated after the wireless electronic device receives a release request from the core network via the first data transmission path. The AS module is activated when a mobile data is generated by the wireless electronic device. The first data transmission path with the core network is established in response to context information received from the second wireless electronic device via the second data transmission path. The mobile data is transmitted to the second wireless electronic device via the second data transmission path.

### CROSS REFERENCE

This application claims the benefit of U.S. Provisional Application Ser. No. 62/405,593, filed on Oct. 7, 2016, and entitled “METHOD OF POWER CONSUMPTION OF A WIRELESS DEVICE”, which is incorporated herein by reference in its entirety.

### TECHNICAL FIELD

The present disclosure generally relates to the field of wireless communication, and pertains particularly to a power saving method of a wireless communication system and mechanism thereof.

### BACKGROUND

Wireless electronic devices, e.g. smartphones and wireless wearable devices, have been widely used in recent years. However, due to Small Form Factor (SFF) design of the wireless electronic device, the battery size is limited such that the capacity of the battery is limited as well. Moreover, the RRM (Radio Resource Management) measurement is performed in LTE (Long Term Evolution) technology even the electronic device is in an idle mode. Power saving for the wireless electronic devices has become more serious when the wireless electronic devices utilize LTE protocols.

### SUMMARY

In one aspect of the present disclosure, a method implemented in a wireless communication system is provided. The wireless communication system includes a plurality of wireless electronic devices respectively having a first data transmission path with a core network. The method includes the following steps. A second data transmission path between a first wireless electronic device and a second wireless electronic device is established. An access stratum (AS) module of the first wireless electronic device is deactivated after the first wireless electronic device receives a release request from the core network via a first data transmission path. The AS module is activated when a mobile data is generated by the first wireless electronic device. The first data transmission path with the core network is established in response to context information received from the second wireless electronic device via the second data transmission path. The mobile data is transmitted to the second wireless electronic device via the second data transmission path.

In another aspect of the present disclosure, a wireless electronic device is provided. The wireless electronic device in a wireless communication system has a first data transmission path with a core network. The wireless electronic device includes a processor configured to perform the following instructions. A second data transmission path with a second wireless electronic device, coupled to the core network, is established. An access stratum (AS) module of the wireless electronic device is deactivated after the wireless electronic device receives a release request from the core network via a first data transmission path. The AS module is activated when a mobile data is generated by the wireless electronic device. The first data transmission path with the core network is established in response to context information received from the second wireless electronic device via the second data transmission path. The mobile data is transmitted to the second wireless electronic device via the second data transmission path.

In yet another aspect of the present disclosure, a wireless electronic device is provided. The wireless electronic device in a wireless communication system has a first data transmission path with a core network. The wireless electronic device includes a processor configured to perform the following instructions. A second data transmission path with a first wireless electronic device is established. Context information for establishing the first data transmission path between the first wireless electronic device and the core network is transmitted to the first wireless electronic device via the second data transmission path. Mobile data is received from the first wireless electronic device via the second data transmission path.

### BRIEF DESCRIPTION OF THE DRAWINGS

Implementations of the present technology will now be described, by way of example only, with reference to the attached figures, wherein:

FIG. 1 is a schematic diagram of a wireless communication system, in accordance with an exemplary embodiment of the present disclosure.

FIG. 2 is a flowchart of a power saving method implemented in the wireless communication system of FIG. 1, in accordance with an exemplary embodiment of the present disclosure.

FIG. 3 is a schematic diagram of another power saving method implemented in the wireless communication system of FIG. 1, in accordance with an exemplary embodiment of the present disclosure.

FIG. 4 is a schematic diagram of context exchange requirements and the related procedures of the wireless electronic device in response to the capability information, in accordance with an exemplary embodiment of the present disclosure.

FIG. 5 is a flow chart of another power saving method of implemented in the wireless communication system of FIG. 1, in accordance with an exemplary embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout the present disclosure will now be presented. The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

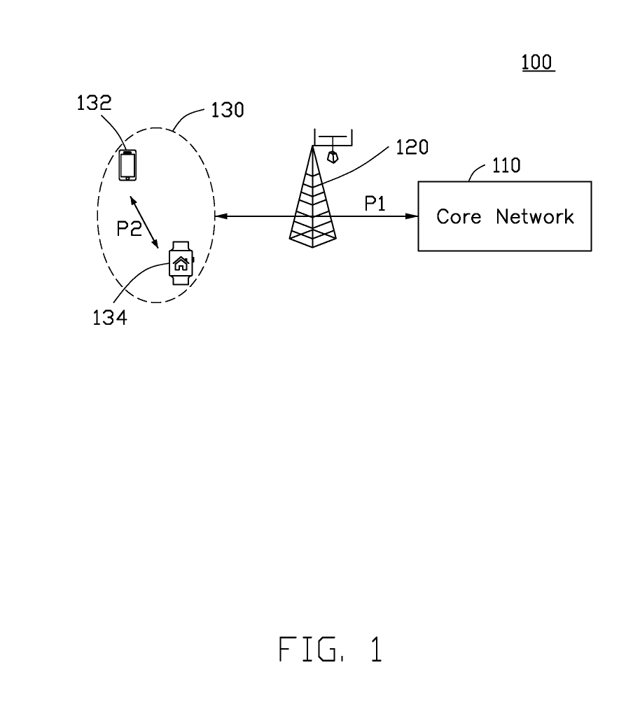

FIG. 1 shows a schematic diagram of a wireless communication system 100, in accordance with an exemplary embodiment of the present disclosure. In this exemplary embodiment, as shown in FIG. 1, the wireless communication system 100 includes a core network 110, a transceiving device 120, and a plurality of wireless electronic devices 130. The wireless electronic devices 130 communicates with the core network 110 via a first data transmission path P1 through the transceiving device 120. In the present exemplary embodiment, as shown in FIG. 1, the wireless electronic devices 130 includes a first wireless electronic device 132 and a second wireless electronic device 134. The first wireless electronic devices 132 communicates with the second wireless electronic device 134 via a second data transmission path P2.

In this exemplary embodiment, the transceiving device 120 includes an eNB (evolved Node B), an RRH (Remote Radio Head), a gNB (gNodeB), a TRP (transmission and reception point), a cell and/or a base station.

In this exemplary embodiment, the wireless electronic devices 130 include a smartphone, a tablet, and/or other wireless wearable devices equipping with an LTE access module or an NR (New Radio) access module. In this exemplary embodiment, the wireless electronic devices 130 communicates with the core network 110 via the first data transmission path P1 with a wireless module, such as a LTE access module, and/or a AP (Access Point) with Wi-Fi access module, etc.

In this exemplary embodiment, the second data transmission path P2 includes a Sidelink interface, which provides a device-to-device communication between the wireless electronic devices 130 in a LTE system. In some exemplary embodiments, the second data transmission path P2 includes a 3GPP RAT (Radio Access Technology) interface such as LTE direct. In some exemplary embodiments, the second data transmission path P2 includes a non-3GPP RAT (Radio Access Technology) interface such as Wi-Fi, Bluetooth, and/or digital enhanced cordless telecommunications (DECT), etc.

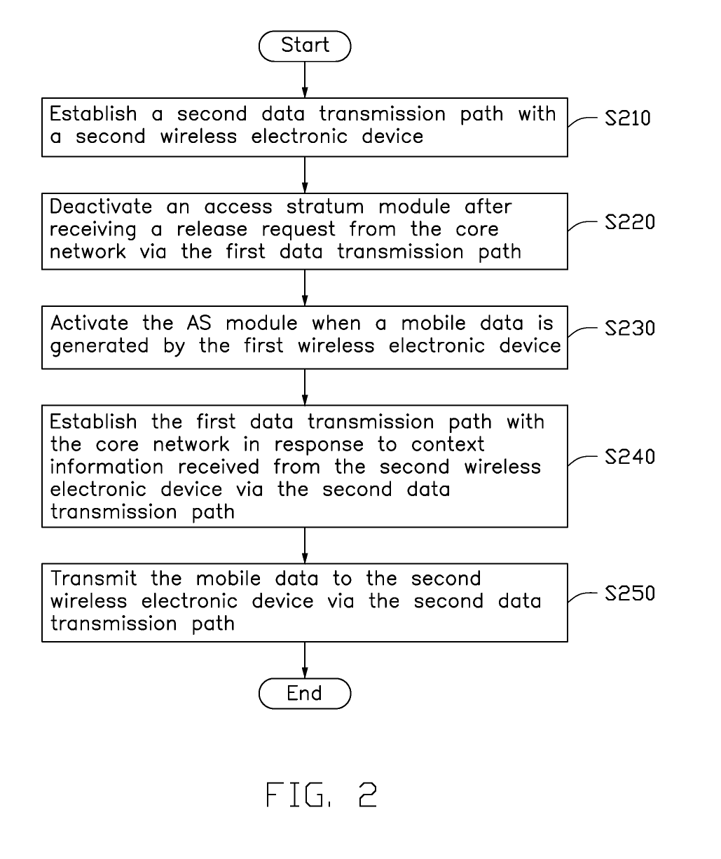

FIG. 2 shows a flow chart of a power saving method implemented in the wireless communication system 100 of FIG. 1, of a second wireless electronic device 134, in accordance with an exemplary embodiment of the present disclosure. In this exemplary embodiment, the first wireless electronic device 132 and the second wireless electronic device 134 are carried by a user, which means that the first wireless electronic device 132 moves with the second wireless electronic device 134. As shown in FIG. 2 and with reference to FIG. 1, in step S210, the second data transmission path P2 is established between the first wireless electronic device 132 and the second wireless electronic device 134. In step S220, an access stratum (AS) module of the first wireless electronic device 132 is deactivated after receiving a release request from the core network 110 via the first data transmission path Pl.

In step S230, the AS module of the first wireless electronic device 132 is activated when a mobile data is generated by the first wireless electronic device 132. In step S240, the first wireless electronic device 132 establishes the first data transmission path P1 with the core network 110 in response to context information received from the second wireless electronic device 134 via the second data transmission path P2. In step S250, the first wireless electronic device 132 transmits the mobile data to the second wireless electronic device 134 via the second data transmission path P2.

In this exemplary embodiment, when the AS module of the first wireless electronic device 132 is deactivated, the first wireless electronic device 132 stops performing data transmission and radio resource management. When the AS module of the first wireless electronic device 132 is activated, the first wireless electronic device 132 acquires context information from the second wireless electronic device 134 via the second data transmission path P2 when needed. In this exemplary embodiment, “Power saving idle (PSI)” is defined for the deactivation of the AS module and therefore the power consumption of the first wireless electronic device 132 performing in PSI mode may be reduced significantly.

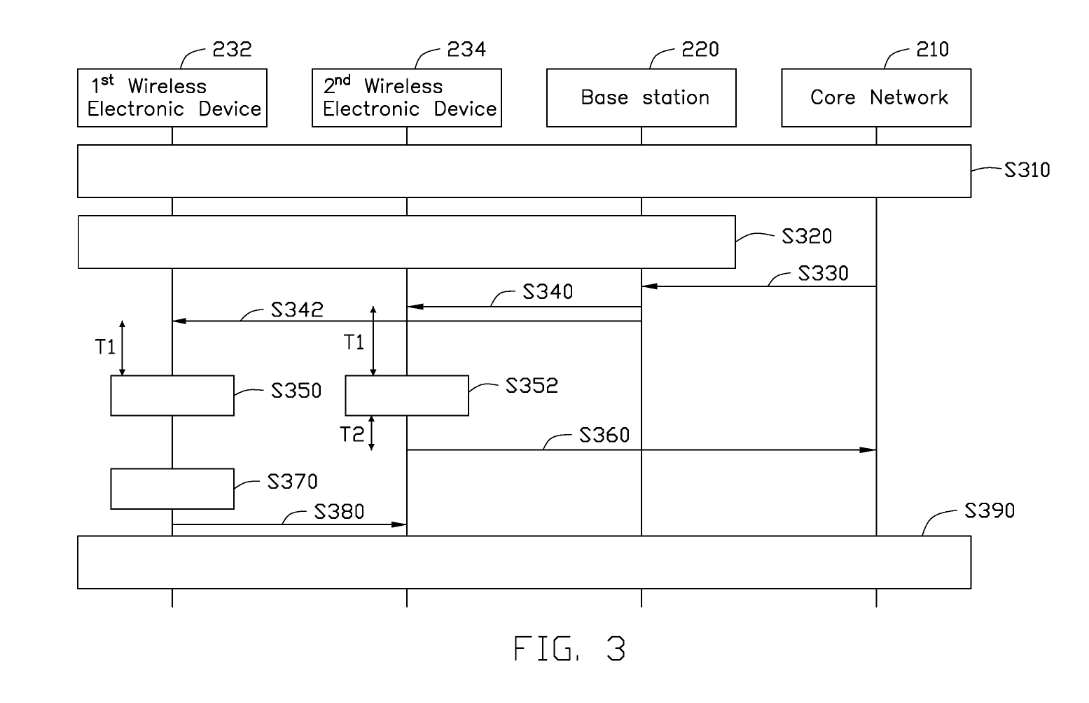

FIG. 3 shows a schematic diagram of another power saving method implemented in the wireless communication system 100 of FIG. 1, in accordance with an exemplary embodiment of the present disclosure. In step S310, RRC connections are established between the wireless electronic devices and the core network 210 via the base station 220, respectively. The wireless electronic devices include a first wireless electronic device 232 and a second wireless electronic device 234. In step S320, the second data transmission path P2 is established between the first wireless electronic device 232 and the second wireless electronic device 234.

In this exemplary embodiment, the second data transmission path P2 with the Sidelink interface is established between the first wireless electronic device 232 and the second wireless electronic device 234 (hereinafter referred to as “Sidelink interface establishment”). Specifically, the first wireless electronic device 232 and the second wireless electronic device 234 associated for the Sidelink interface establishment is determined by a proximity detection. If the proximity detection results show that the first wireless electronic device 232 is close to the second wireless electronic device 234 is (for example, the received proximity discovery signal strength is larger than a threshold, e.g. 10 dBm), the first wireless electronic device 232 and the second wireless electronic device 234 are identified in the same wireless communication network.

When the first wireless electronic device 232 and the second wireless electronic device 234 are in the same wireless communication network, the Sidelink interface is established between the first wireless electronic device 232 and the second wireless electronic device 234. In this exemplary embodiment, the proximity detection is realized by the Sidelink communication (specified by 3GPP). In some exemplary embodiments, the proximity detection is realized by other short-range communication technology (e.g. bluetooth). In other exemplary embodiments, the first wireless electronic device 232 and the second wireless electronic device 234 associated for the Sidelink interface establishment are manually set by a user.

In this exemplary embodiment, the Sidelink interface establishment is initiated by the base station 220. The Sidelink interface establishment includes a step of configuring a deactivation of the AS module of the wireless electronic device. For example, the wireless electronic device, the AS module of which is to be deactivated, (e.g. the first wireless electronic device 232) is decided by the base station 220, and the corresponding deactivation configuration is provided and transmitted, by the base station 220, to the wireless electronic devices 232 and 234.

In some exemplary embodiments, the Sidelink interface establishment including the deactivation configuration is initiated by one of the first wireless electronic device 232 and the second wireless electronic device 234. The deactivation configuration is then transmitted, by one of the first wireless electronic device 232 and the second wireless electronic device 234, to the other one of the second wireless electronic device and the first wireless electronic device 232, and the base station 220.

In some other exemplary embodiments, the Sidelink interface establishment including the deactivation configuration is initiated by the core network 210. The deactivation configuration is transmitted, by the core network 210, to the first wireless electronic device 232 and the second wireless electronic device 234 via the base station 220.

In some exemplary embodiments, the Sidelink interface establishment is performed or updated after one of the wireless electronic devices is powered on. In some other exemplary embodiments, the Sidelink interface establishment is performed or updated when one of the wireless electronic devices is being released to RRC idle mode. In some other exemplary embodiments, the Sidelink interface establishment is performed or updated when the battery of one of the wireless electronic devices falls below a predefined level.

In some other exemplary embodiments, the Sidelink interface establishment is performed or updated on demand, when one of the wireless electronic devices receive requests, in a predetermined time period, from the core network or other devices. In some other exemplary embodiments, the Sidelink interface establishment is performed or updated on demand, when a timer expired after one of the wireless electronic devices entering into the RRC idle mode without any service request. In other exemplary embodiments, the Sidelink interface establishment is performed or updated in response to the variation of the traffic statistics, e.g. the data capacity or bandwidth limits of the voice/video services.

In step S330, a release request, generated by the core network 210, for performing idle mode of the first wireless electronic device 232 is transmitted to the base station 220. In steps S340 and 5342, the release request for performing idle mode of the first wireless electronic device 232 is simultaneously and respectively transmitted, by the base station 220, to the first wireless electronic device 232 and the second wireless electronic device 234. In this exemplary embodiment, the release request for performing RRC idle mode of the first wireless electronic device 232 includes a PSI timer.

In some exemplary embodiments, the release request for performing idle mode of the first wireless electronic device 232 includes an identifier of the wireless electronic device performing the idle mode. After the first wireless electronic device 232 receives the release request for performing idle mode, the first wireless electronic device 232 releases the RRC connection and enters the idle mode. The PSI timer is then started. The PSI timer may stop when the first wireless electronic device tries to re-establish the first transmission data path. When the PSI timer expires (e.g. after a predetermined time T1), the AS module of the first wireless electronic device 232 is deactivated in step S350 and the first wireless electronic device 232 enters the PSI mode.

The second wireless electronic device 234 also starts the PSI timer when the release request for performing idle mode of the first wireless electronic device 232 is received. When the PSI timer of the second wireless electronic device 234 is expired, in step S352, the second wireless electronic device 234 recognizes that the first wireless electronic device 232 is in the PSI mode. It is noted that the PSI timer of the second wireless electronic device 234 will be re-started when Mobile Originated (MO) data generated by the first wireless electronic device 232 is received by the second wireless electronic device 234.

After the second wireless electronic device 234 recognizes that the first wireless electronic device 232 is in the PSI mode, the second wireless electronic device 234 starts a tracking area update (TAU) timer. When a TAU timer expires (e.g. after a predetermined time T2), step S360 is performed. In step S360, the second wireless electronic device 234 transmits a TAU request to the core network 210 via the base station 220. After the core network 210 receives the TAU request, the core network 210 provides update to the corresponding profile information of the first wireless electronic device 232. In this exemplary embodiment, the profile information includes a location of the first wireless electronic device 232.

In step S370, when the MO data is generated by the first wireless electronic device 232, the AS module of the first wireless electronic device 232 is activated and the first wireless electronic device 232 tries to enter an RRC connected mode (i.e., establishing the RRC connection). In step S380, the MO data is transmitted from the first wireless electronic device 232 to the second wireless electronic device 234 via the Sidelink interface established in step S320. After the second wireless electronic device 234 receives the MO data, the second wireless electronic device 234 recognizes that the first wireless electronic device 232 is in the RRC connected mode. In step S390, the RRC connection including the first wireless electronic device 232, the base station 220 and the core network 210 is established.

In some exemplary embodiments, the wireless electronic devices exchanges capability information with each other during the Sidelink establishment. For example, the first wireless electronic device 232 transmits capability information to the second wireless electronic device 234. In this exemplary embodiment, the capability information includes a support frequency band, a radio access technology, and a public land mobile network. In some exemplary embodiments, the capability information includes number of transceivers and antennas, support of 3GPP features (e.g. Carrier Aggregation, D2D), available battery life, user's preference setting, positioning capability and granularity, OS version and relating API, and other hardware capability (e.g. screen size, battery size, etc). The second wireless electronic device 234 decides the context information which is necessary to be exchanged, in response to the capability information of the first wireless electronic device 232 and the second wireless electronic device 234, among the first wireless electronic device 232 and the second wireless electronic device 234.

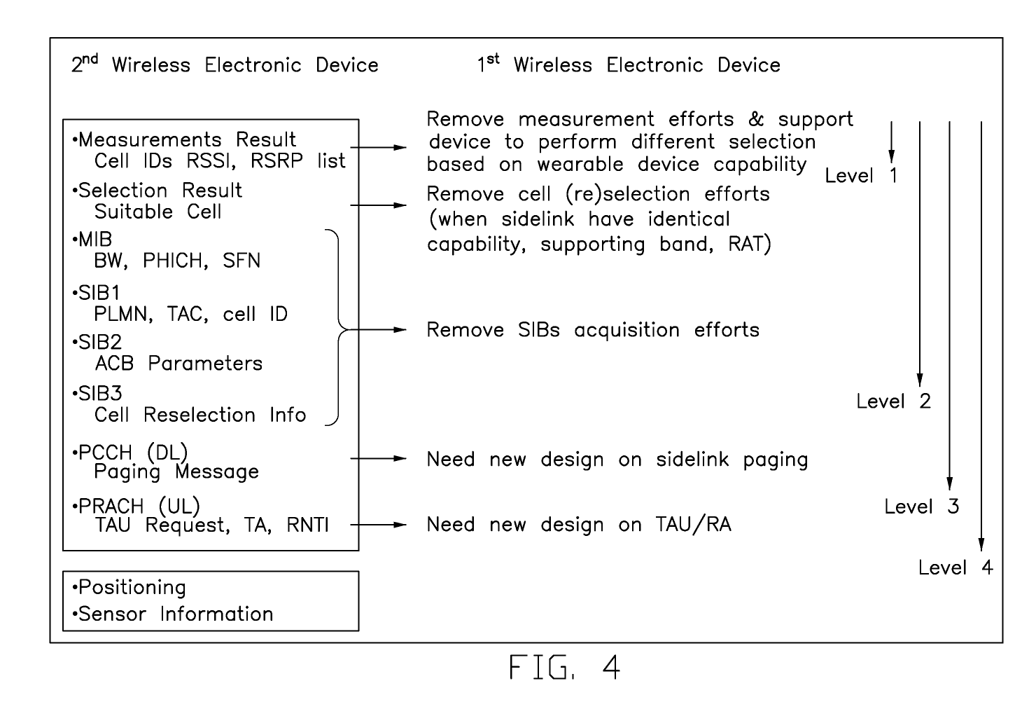

FIG. 4 shows a schematic diagram of context exchange requirements and the related procedures of a wireless electronic device, in accordance with an exemplary embodiment of the present disclosure. The context information relates to procedures performed by the wireless electronic device in the idle mode. As shown in FIG. 4, in this exemplary embodiment, the context information includes measurement results, such as Cell IDs with corresponding received signal strength indicator (RSSI), and reference signal received power (RSRP).

In this exemplary embodiment, the context information further includes selection results, e.g. a suitable cell with an ID. In this exemplary embodiment, the context information further includes master information block (MIB) information, e.g. cell bandwidth (BW), physical hybrid ARQ indicator channel (PHICH) configuration, and system frame number (SFN). In this exemplary embodiment, the context information further includes system information block (SIB) SIB1 to SIB3 information, which includes PLMN list, tracking area code (TAC), cell ID, access class barring (ACB) parameters, and cell reselection information. In this exemplary embodiment, the context information further includes paging control channel (PCCH) configuration (e.g. paging message including paging purpose and record), and physical random access channel (PRACH) configuration (e.g. TAU request, timing advance (TA) and radio network temporary identifier (RNTI)). In some exemplary embodiments, the context information includes positioning information and other sensor information. The second wireless electronic device shares its positioning information and its sensor information with the first wireless electronic device. For example, the sensor information include temperature, atmospheric, pressure, altitude, etc.

In this exemplary embodiment, as shown in FIG. 4, the context exchange requirements are divided into four levels. The context exchange requirements level is determined by the second wireless electronic device in response to the capability information of the first wireless electronic device. For example, if the RAT of the first wireless electronic device is different from the RAT of the second wireless electronic device, the context exchange requirements level is determined as Level 1, by the second wireless electronic device.

In some exemplary embodiments, if the PLMN of the first wireless electronic device is different from the PLMN of the second wireless electronic device, the context exchange requirements level is determined as Level 1 by the second wireless electronic device. As shown in FIG. 4, at Level 1, the first wireless electronic device skips the measuring procedures while the second wireless electronic device performs the measuring procedures (e.g. measuring a base station information). Afterwards, the second wireless electronic device transmits the measuring results to the first wireless electronic device via the second data transmission path.

Since the RAT of the first wireless electronic device is different from the RAT of the second wireless electronic device, the first wireless electronic device may select its own suitable cell based on the corresponding measuring results received from the first wireless electronic device. In some exemplary embodiments, the second wireless electronic device performs additional measurements for all of the wireless electronic device connected with the second wireless electronic device via the second data transmission path.

In this exemplary embodiment, if the RAT and PLMN of the first wireless electronic device is the same as the RAT and PLMN of the second wireless electronic device, the context exchange requirements level is determined as Level 2 by the second wireless electronic device. As shown in FIG. 4, at Level 2, the first wireless electronic device further skips the cell selection/reselection procedures while the second wireless electronic device performs the cell selection/reselection procedures.

Afterwards, the second wireless electronic device transmits the corresponding cell selection information to the first wireless electronic device via the second data transmission path. The first wireless electronic device performs the paging procedures in response to received cell selection information from the first wireless electronic device. In some exemplary embodiments, the second wireless electronic device transmits the corresponding MIB information, SIB1, SIB2, SIB3 information to the first wireless electronic device via the second data transmission path.

In this exemplary embodiment, as shown in FIG. 4, at Level 3, the first wireless electronic device further skips the paging procedures while the second wireless electronic device performs the paging procedures for the first wireless electronic device. Afterwards, the second wireless electronic device transmits the corresponding paging information to the first wireless electronic device via the second data transmission path. In this exemplary embodiment, the first wireless electronic device may perform the tracking area update.

In some exemplary embodiments, the second wireless electronic device tries to acquire SIBx and forward the SIBx information when the second wireless electronic device receives a paging message indicating SIB modification or earthquake and tsunami warning system (ETWS) notification from the base station. In some other exemplary embodiments, the second wireless electronic device perform a stepwise paging procedure when the second wireless electronic device receives a paging message indicating the first wireless electronic device to establish the RRC connection. In the stepwise paging procedure, the second wireless electronic device send a paging notification to the corresponding device through the Sidelink interface.

In some exemplary embodiments, at Level 3, a receiving cycle is configured for the first wireless electronic device to monitor the Sidelink interface for receiving paging notification periodically. The configuration of receiving cycle shall take QoS (paging delay) into account. It is also noticed that the paging frame (PF), paging opportunity (PO), paging ID for the first wireless electronic device and second wireless electronic device have new designs to have common parameters (PF/PO/Paging ID) during paging process. Alternatively, if there are no common paging parameters, the second wireless electronic device shall monitor every relating PF/PO and check the listed IDs in paging message.

In this exemplary embodiment, as shown in FIG. 4, at Level 4, the first wireless electronic device further skips the tracking area update procedures while the second wireless electronic device performs the tracking area update procedures for the wireless electronic device. Afterwards, the second wireless electronic device transmits the corresponding tracking area update information to the first wireless electronic device via the second data transmission path. In some exemplary embodiments, at Level 4, the first wireless electronic device share resource identifier and scheduling information with the second wireless electronic device.

At Level 4, the first wireless electronic device and the second wireless electronic device have a common NAS, and the base station treats the first wireless electronic device and the second wireless electronic device as a single device and responds a common RAR when the second wireless electronic device initiate RA for the group to acquire tracking area (TA) information and resource grant. After receiving RAR (Random Access Response), the second wireless electronic device may broadcast the corresponding information and the first wireless electronic device may perform joint processing to receive and transmit common packets. When the second wireless electronic device is connected with the first wireless electronic device, the second wireless electronic device could monitor Physical Downlink Control Channel (PDCCH) and perform stepwise resource grant to decode the common grant for the first wireless electronic device or the first wireless electronic device could monitor PDCCH.

In this exemplary embodiment, the first wireless electronic device could remove the efforts of RA (including power ramping) to reduce the power consumption of the first wireless electronic device. Therefore, the first wireless electronic device is prevented from simultaneously performing the RA and contention procedures at the same time.

The context information is forwarded on demand or dedicatedly. In some exemplary embodiments, a random access process shall be configured between the first wireless electronic device and the second wireless electronic device. The first wireless electronic device sends a dedicated preamble via the second data transmission interface and the second wireless electronic device recognizes the device and forward corresponding context information via the second data transmission interface.

In some other exemplary embodiments, the second wireless electronic device broadcasts periodically acquired information (the cycle shall be configurable) or the second wireless electronic device broadcasts a basic version (or flag) of acquired information and forward the details of the acquired information to other devices on demand.

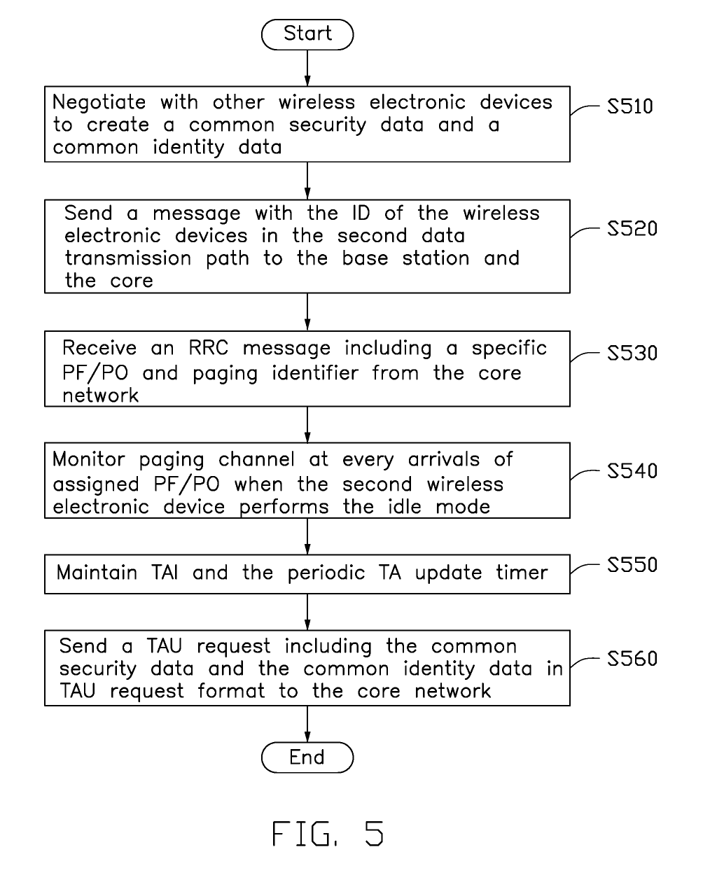

FIG. 5 shows a flow chart of another power saving method of implemented in the wireless communication system 100 of FIG. 1, in accordance with an exemplary embodiment of the present disclosure. In this exemplary embodiment, the wireless electronic devices share a common DL & UL signaling with each other via the second data transmission path for receiving and transmitting message. As mentioned in aforementioned context exchange requirements, the second wireless electronic device generates a unified TAU request to the core network and receive a common paging message from the base station.

As shown in FIG. 5, in step S510, the second wireless electronic device negotiates with the other wireless electronic devices to create a common security data (e.g. a NAS key set identifier, “eKSI”) and a common identity data (e.g. a packet temporary mobile subscriber identity (P-TMSI) signature) when the second data transmission path is established. In some exemplary embodiments, the second wireless electronic device may use its security and ID for the second wireless electronic device and all of the other associated wireless electronic devices. In step S520, when the second wireless electronic device is connected with the other wireless electronic devices, the second wireless electronic device send a message with the ID of the other associated wireless electronic devices in the second data transmission path to the base station and the core network.

In step S530, the second wireless electronic device receives an RRC message including a specific PF/PO and a common paging identifier from the core network. In step S540, when the second wireless electronic device enters into the idle mode, the second wireless electronic device starts to monitor paging channel at every arrivals of assigned PF/PO. If a paging message, received from the base station, includes the common paging identifier, the second wireless electronic device transmits a wake-up message to the associated wireless electronic devices via the second data transmission path for activating the associated wireless electronic devices. Otherwise, the second wireless electronic device and the associated wireless electronic device remain at the idle mode if the paging message does not include the corresponding paging identifier.

In step S550, the second wireless electronic device maintains the tracking area identity (TAI) and the periodic TA update timer. The second wireless electronic device initiates TAU if the second wireless electronic device enters a new TA or the timer is expired.

In step S560, the second wireless electronic device sends a TAU request, including the common security data (e.g. eKSI), the common identity data (e.g. P-TMSI signature) and other specified information in TAU request format, to the core network. When the core network receives the TAU request and recognize the second wireless electronic device, the core network will treat the TAU request as a group request and update corresponding profile information of the wireless electronic devices in the second data transmission path.

In this exemplary embodiment, the other associated wireless electronic devices are treated as un-reachable UEs by the core network. For example, the core network is aware of that the associated wireless electronic devices is not able to perform TAU, and the core network could not employ paging process to push services to the associated wireless electronic devices subsequently.

The exemplary embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

According to above embodiments of the present disclosure, various kinds of devices, and methods of a wireless communication system having power saving mechanism are provided. A second data transmission path between a first wireless electronic device and a second wireless electronic device is established. An access stratum module of the first wireless electronic device is deactivated after the first wireless electronic device receives a release request from the core network via the first data transmission path. The AS module is activated when a mobile data is generated by the first wireless electronic device.

The first data transmission path with the core network is established in response to context information received from the second wireless electronic device via the second data transmission path. The mobile data is transmitted to the second wireless electronic device via the second data transmission path. Therefore, the first wireless electronic device may reduce the power consumption by deactivating its AS module in the idle mode.

Moreover, the second wireless electronic device may perform the measuring procedures and the TAU procedures for the first wireless electronic device in the idle mode, and receive the paging message for waking up the first wireless electronic device on demands. Furthermore, the wireless electronic devices may communicate with each other and exchange contents in response to the capability information of the wireless electronic devices via the second data transmission path without connecting to the core network.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A method implemented in a wireless communication system including a plurality of wireless electronic devices respectively having a first data transmission path with a core network, the method comprising:
establishing a second data transmission path between a first wireless electronic device of the wireless electronic devices and a second wireless electronic device of the wireless electronic devices;
deactivating, by the first wireless electronic device, an access stratum (AS) module of the first wireless electronic device after the first wireless electronic device receives a release request from the core network via the first data transmission path;
activating, by the first wireless electronic device, the AS module when a mobile data is generated by the first wireless electronic device;
establishing, by the first wireless electronic device, the first data transmission path with the core network in response to context information received from the second wireless electronic device via the second data transmission path; and
transmitting, by the first wireless electronic device, the mobile data to the second wireless electronic device via the second data transmission path.

2. The method of claim 1, wherein the step of establishing the second data transmission path between the first wireless electronic device and the second wireless electronic device comprises:
configuring a deactivation of the AS module of the first wireless electronic device; and
receiving, by the second wireless electronic device, a deactivation configuration of the first wireless electronic device.

3. The method of claim 1, wherein the step of establishing the second data transmission path between the first wireless electronic device and the second wireless electronic device comprises:
transmitting, by the first wireless electronic device, capability information of the first wireless electronic device to the second wireless electronic device.

4. The method of claim 3, further comprising:
determining, by the second wireless electronic device, a context exchange requirement in response to the capability information of the first wireless electronic device; and
transmitting, by the second wireless electronic device, the context information to the first wireless electronic device in response to the context exchange requirement.

5. The method of claim 4, wherein the context information includes cell selection information.

6. The method of claim 4, further comprising:
generating, by the second wireless electronic device, common security data and common identity data for both of the first wireless electronic device and the second wireless electronic device;
transmitting, by the second wireless electronic device, a tracking area update request including the common security data and the common identity data to the core network;
updating, by the core network, profile information of the first wireless electronic device and the second wireless electronic device in response to the tracking area update request; and
receiving, by the second wireless electronic device, a common page identifier from the core network.

7. The method of claim 4, further comprising:
receiving, by the second wireless electronic device, a paging message including the common page identifier from the core network;
transmitting, by the second wireless electronic device, a wakeup instruction to the first wireless electronic device via the second data transmission path; and
activating, by the first wireless electronic device, the AS module in response to the wakeup instruction.

8. The method of claim 2, wherein the step of establishing the second data transmission path between the first wireless electronic device and the second wireless electronic device further comprises:
transmitting, by the core network, a request to the first electronic device and the second electronic device, wherein the request includes a timer; and
deactivating, by the first wireless electronic device, the AS module when the timer expires.

9. A wireless electronic device, having a first data transmission path with a core network, in a wireless communication system, comprising:
a processor configured to perform instructions for:
establishing a second data transmission path with a second wireless electronic device, coupled to the core network, in the wireless communication system;
deactivating an access stratum (AS) module of the wireless electronic device after the wireless electronic device receives a release request from the core network via the first data transmission path;
activating the AS module when a mobile data is generated by the wireless electronic device;
establishing the first data transmission path with the core network in response to context information received from the second wireless electronic device via the second data transmission path; and
transmitting the mobile data to the second wireless electronic device via the second data transmission path.

10. The wireless electronic device of claim 9, wherein the processor is further configured to perform instructions for:
configuring a deactivation of the AS module of the first wireless electronic device; and
transmitting a deactivation configuration to the second wireless electronic device.

11. The wireless electronic device of claim 9, wherein the processor is further configured to perform instructions for:
receiving a deactivation configuration from a base station.

12. The wireless electronic device of claim 9, wherein the processor is further configured to perform instructions for:
transmitting capability information of the wireless electronic device to the second wireless electronic device.

13. The wireless electronic device of claim 12, wherein the processor is further configured to perform instructions for:
receiving the context information from the second wireless electronic device, wherein the context information is generated by the second wireless electronic device in response to the capability information of the wireless electronic device.

14. The wireless electronic device of claim 13, wherein the context information includes cell selection information.

15. The wireless electronic device of claim 13, wherein the processor is further configured to perform instructions for:
receiving a wakeup instruction from the second wireless electronic device via the second data transmission path; and
activating the AS module in response to the wakeup instruction.

16. The wireless electronic device of claim 10, wherein the processor is further configured to perform instructions for:
receiving a request from the core network, wherein the request includes a timer; and
deactivating the AS module when the timer expires.

17. A wireless electronic device, having a first data transmission path with a core network, in a wireless communication system, comprising:
a processor configured to perform instructions for:
establishing a second data transmission path with a first wireless electronic device in the wireless communication system;
transmitting context information, for establishing the first data transmission path between the first wireless electronic device and the core network, to the first wireless electronic device via the second data transmission path; and
receiving mobile data from the first wireless electronic device via the second data transmission path.

18. The wireless electronic device of claim 17, wherein the processor is further configured to perform instructions for:
configuring a deactivation of the AS module of the first wireless electronic device; and
transmitting a deactivation configuration to the first wireless electronic device.

19. The wireless electronic device of claim 17, wherein the processor is further configured to perform instructions for:
receiving a deactivation configuration from the first wireless electronic device.

20. The wireless electronic device of claim 17, wherein the processor is further configured to perform instructions for:
receiving a deactivation configuration from a base station.

21. The wireless electronic device of claim 17, wherein the processor is further configured to perform instructions for:
receiving capability information of the first wireless electronic device from the first wireless electronic device.

22. The wireless electronic device of claim 21, wherein the processor is further configured to perform instructions for:
determining a context exchange requirement in response to the capability information of the first wireless electronic device; and
transmitting the context information to the first wireless electronic device in response to the context exchange requirement.

23. The wireless electronic device of claim 22, wherein the processor is further configured to perform instructions for:
performing a cell selection; and
storing cell selection information as the context information.

24. The wireless electronic device of claim 22, wherein the processor is further configured to perform instructions for:
generating a common security data and a common identity data for both of the first wireless electronic device and the wireless electronic device;
transmitting a tracking area update request including the common security data and the common identity data to the core network, wherein the tracking area update request is configured for updating profile information of the first wireless electronic device and the wireless electronic device; and
receiving a common page identifier from the core network.

25. The wireless electronic device of claim 22, wherein the processor is further configured to perform instructions for:
receiving a paging message including a common page identifier from the core network; and
transmitting a wakeup instruction to the first wireless electronic device via the second data transmission path, wherein the first wireless electronic device activates the AS module in response to the wakeup instruction.

26. The wireless electronic device of claim 18, wherein the processor is further configured to perform instructions for:
receiving a request from the core network, wherein the request includes a timer; and
communicating with the core network when the timer expires.
